(19) United States
(12) Patent Application Publication
(10) Pub. No.: US 2019/0045003 A1
(43) Pub. Date: Feb. 7, 2019

(54) COLLECTIVE COMMUNICATION OPERATION

(71) Applicant: Intel Corporation, Santa Clara, CA (US)

(72) Inventors: Charles Archer, Chicago, IL (US); Akhil Langer, Champaign, IL (US)

(73) Assignee: Intel Corporation, Santa Clara, CA (US)

(21) Appl. No.: 15/865,826

(22) Filed: Jan. 9, 2018

(51) Int. Cl. H04L 29/08; H04L 29/06

(52) U.S. Cl. CPC H04L 67/1095; H04L 12/427; H04L 69/04; H04L 67/1097

(57) ABSTRACT

Particular embodiments described herein provide for a device that can be configured to receive data from a first node in a bi-directional chain of nodes, perform a reduction operation that is part of a collective communication operation using the data from the first node and data on the node to create a first intermediate result, store the first intermediate result in memory, communicate the first intermediate result to a second node, receive second data from the second node, perform the reduction operation that is part of the collective communication operation using the second data from the second node and the data on the node to create a second intermediate result, communicate the second intermediate result to the first node, and perform the collective communication operation using the second data from the second node and the first intermediate collective communication operation result to create a collective communication operation result.

### TECHNICAL FIELD

This disclosure relates in general to the field of computing, and more particularly, to a collective communication operation.

### BACKGROUND

Interconnected networks are a critical component of some modern computer systems. As processor and memory performance, as well as the number of processors in a multicomputer system, continues to increase, multicomputer interconnected networks are becoming even more critical. One characteristic of an interconnected network is parallel computing. One aspect of parallel computing is the ability to perform collective communication operations. Generally, a collective communication operation can be thought of as a communication operation that involves a group of computing units commonly referred to as nodes.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a block diagram of a communication system to enable a collective communication operation in accordance with an embodiment of the present disclosure;

FIGS. 2A-2C are block diagrams illustrating example details associated with a communication system to enable a collective communication operation in accordance with an embodiment of the present disclosure;

FIGS. 3A-3D are block diagrams illustrating example details associated with a communication system to enable a collective communication operation in accordance with an embodiment of the present disclosure;

FIGS. 4A-4D are block diagrams illustrating example details associated with a communication system to enable a collective communication operation in accordance with an embodiment of the present disclosure;

FIG. 5 is a block diagram of a communication system to enable a collective communication operation in accordance with an embodiment of the present disclosure;

FIG. 6 is a flowchart illustrating potential operations that may be associated with the communication system in accordance with an embodiment;

FIG. 7 is a flowchart illustrating potential operations that may be associated with the communication system in accordance with an embodiment; and

FIG. 8 is a flowchart illustrating potential operations that may be associated with the communication system in accordance with an embodiment.

The FIGURES of the drawings are not necessarily drawn to scale, as their dimensions can be varied considerably without departing from the scope of the present disclosure.

### DETAILED DESCRIPTION

The following detailed description sets forth example embodiments of apparatuses, methods, and systems relating to a communication system for enabling a collective communication operation. Features such as structure(s), function(s), and/or characteristic(s), for example, are described with reference to one embodiment as a matter of convenience; various embodiments may be implemented with any suitable one or more of the described features.

In the following description, various aspects of the illustrative implementations will be described using terms commonly employed by those skilled in the art to convey the substance of their work to others skilled in the art. However, it will be apparent to those skilled in the art that the embodiments disclosed herein may be practiced with only some of the described aspects. For purposes of explanation, specific numbers, materials and configurations are set forth in order to provide a thorough understanding of the illustrative implementations. However, it will be apparent to one skilled in the art that the embodiments disclosed herein may be practiced without the specific details. In other instances, well-known features are omitted to not obscure the illustrative implementations.

In the following detailed description, reference is made to the accompanying drawings that form a part hereof where like numerals designate like parts throughout, and in which is shown, by way of illustration, embodiments that may be practiced. It is to be understood that other embodiments may be utilized and structural or logical changes may be made without departing from the scope of the present disclosure. Therefore, the following detailed description is not to be taken in a limiting sense. For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C).

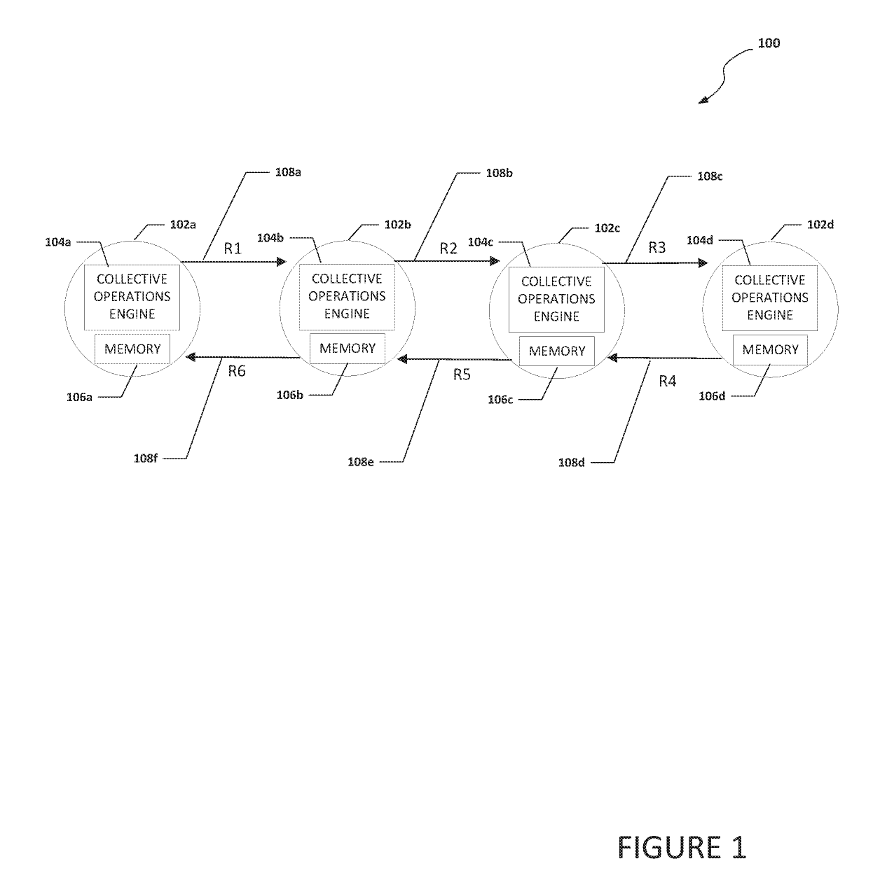

FIG. 1 is a block diagram of a system 100 to illustrate an example use of a collective communication operation. System 100 can include a plurality of nodes 102a-102d. Each node can include a collective operations engine and memory. For example, node 102a can include a collective operations engine 104a and memory 106a, node 102b can include a collective operations engine 104b and memory 106b, node 102c can include a collective operations engine 104c and memory 106c, and node 102d can include a collective operations engine 104d and memory 106d.

During operation, nodes 102a-102d can communicate on a two way or bi-directional chain network (e.g., an edge disjointed ring). For example, node 102a can communicate with node 102b on communication path 108a, node 102b can communicate with node 102c on communication path 108b, and node 102c can communicate with node 102d on communication path 108c. In the opposite direction, node 102d can communicate with node 102c on communication path 108d, node 102c can communicate with node 102b on communication path 108e, and node 102b can communicate with node 102a on communication path 108f.

In an example, system 100 can be configured to facilitate a concurrent exchange approach for facilitating a collective communication operation. More specifically, system 100 can be configured to perform pipelined parallel prefix operations in opposite directions along a bi-directional communication path. At each node, the corresponding results from two prefix reductions (a prefix reduction from one direction and a second prefix reduction from the other direction) is reduced to give an expected allreduce result on each node. The nodes may be part of an interconnected network and may be part of a multi-tiered topology network or some other parallel computing architecture.

In a specific example, a node (e.g., node 102b) can be configured to receive data from a first node (e.g., node 102a) in a bi-directional chain of nodes. The data can be used to perform an operation (e.g., a reduction operation) that is part of a collective communication operation using the data from the first node and data on the node to create an intermediate result. The intermediate result can be stored in memory and communicated to a second node (e.g. node 102c). Second data can be received from the second node and the operation that is part of the collective communication operation using the second data from the second node and the data on the node can be performed to create a second intermediate result. The second intermediate result can be communicated to the first node. The operation that is part of the collective communication operation can be performed using the second data from the second node and the intermediate result to create a collective communication operation result. In an example, the collective communication operation is an allreduce operation. The chain of nodes can be an edge disjointed ring and the first node and the second node can be part of a multi-tiered topology network.

It is to be understood that other embodiments may be utilized and structural changes may be made without departing from the scope of the present disclosure. Substantial flexibility is provided by system 100 in that any suitable arrangements and configuration may be provided without departing from the teachings of the present disclosure.

For purposes of illustrating certain example techniques of system 100, it is important to understand the communications that may be traversing the network environment. The following foundational information may be viewed as a basis from which the present disclosure may be properly explained.

Users have more communications choices than ever before. A number of prominent technological trends are currently afoot (e.g., more computing devices, more connected devices, etc.). One current trend is interconnected networks. Interconnected networks are a critical component of some modern computer systems. From large scale systems to multicore architectures, the interconnected network that connects processors and memory modules significantly impacts the overall performance and cost of the system. As processor and memory performance continue to increase, multicomputer interconnected networks are becoming even more critical as they largely determine the bandwidth and latency of remote memory access.

One type of interconnected network allows for parallel computing. Parallel computing is a type of computation in which many calculations or the execution of processes are carried out simultaneously on interconnected nodes. One aspect of parallel computing is a collective communication operation. For example, an allreduce operation is a collective communication operation that can be performed on a parallel system. In an allreduce collective operation, every node contributes data and the data from the nodes is reduced by applying a reduction operation. The reduced data is then made available to all the nodes. Allreduce collective operations are typically used in many machine learning and high performance computing (HPC) applications. Current solutions used to perform an allreduce operation are algorithms such as a tree based reduce followed by a broadcast, recursive exchange, Rabensifner's algorithm (a reducescatter followed by an allgather) and rings. When an allreduce operation is performed on large data, a pipelined ring based algorithm is typically used to avoid network contention. A reduction operation is an operation where two or more instances of data are reduced to a single instance of data (e.g., a sum operation, multiplication operation, maximum (max) operation, minimum (min) operation, etc.)

The allreduce operation is typically implemented as a reduce operation followed by a broadcast of the results. In a ring based reduce algorithm, a node “n” (where n does not equal zero) receives data from node (n−1)modular (%) x, reduces the received data with its own data, and sends the reduced data to node (n+1)% x, where “x” is the total number of nodes. The reduction starts at node zero and travels in one direction to end at node x−1. Once the allreduce operation is complete, the results can be broadcast in the opposite direction (e.g., node “n” (where n does not equal zero) sends the results to node (n−1)% x. The broadcast will start at node x−1 and end at node 0. The time taken for the complete allreduce operation is the network bandwidth plus a reduction constant, times the message size, plus the network latency, times the total number of nodes minus one or (x−1)(α+(β+γ)m) where “α” represents the network latency, “m” represents the message size, “β” represents the network bandwidth (in seconds/byte), and “γ” represents a reduction constant. The reduction constant can be determined by the rate at which a single instance of the reduction operation can be performed. The time taken to broadcast the results is the network bandwidth times the message size, plus the network latency, times the total number of nodes minus one or (x−1)(α+βm). Therefore, the total time for the allreduce operation is 2(x−1)(α+βm)+(n−1))γm).

In a pipelined ring approach, the data for the allreduce operation can be divided into “t” chunks where each size of the chunk is of size “s” or m=t*s where “m” represents the total data (e.g., message) size, “t” represents the number of chunks, and “s” represents the size of each chunk. The chunks can be sent one at a time and processed as they arrive. At the end of the reduce operation, the results can be broadcast similar to the ring based approach described above. The time to process a first chunk is 2(n−1)((60 +βs)+(n−1)γs and the time to process subsequent chunks takes an additional time of max(β,γ)s instead of (β+γ) because the reduction of one chunk can be overlapped with the sending of the next chunk. Because there are a total of n−1 chunks, the total time to pipeline the allreduce operation is 2(n−1)((α+βs)+(n−1)γs+max(β+γ)(m−s). Because the broadcast of the result of the reduce operation takes time, what is needed is a system, method, apparatus, etc. to perform an allreduce operation that at least does not require a broadcast of the results.

A communication system that allows for a collective communication operation, as outlined in FIG. 1, can resolve these issues (and others). In an example, system 100 can be configured to facilitate a collective communication operation, especially an allreduce operation, that does not require a broadcast of the results. For example, system 100 can be configured to facilitate a concurrent exchange approach for facilitating a collective communication operation. More specifically, system 100 can be configured to form two rings of all the nodes to be used in the collective communication operation and concurrently perform pipelined parallel prefix operations in opposite directions along each of the two rings. At each node, the corresponding results from the two prefix reductions is reduced to give the expected allreduce result on each node. The nodes may be part of an interconnected network and may be part of a multi-tiered topology network or some other parallel computing architecture.

One messaging system designed for parallel computing architectures is message passing interface (MPI). MPI defines an application programming interface (API) for message passing in parallel programs. MPI defines both point-to-point communication routines, such as sends and receives between pairs of processes and collective communication routines that involve a group of processes that need to perform some operation together. For example, MPI can define broadcasting data from a root process to other processes and finding a global minimum or maximum of data values on all processes (one type of a reduction operation). Collective communication operations provide a simple interface for commonly required operations and can also enable a system to optimize these operations for a particular architecture. As a result, collective communication is widely and frequently used in many applications and the performance of collective communication routines is often critical to the performance of an overall system or application.

In an implementation, system 100 can configured to perform two parallel prefix reductions concurrently in opposite directions on two rings (e.g., edge disjointed rings). In one direction, a node (n) (where the node does not equal zero) receives data from node (n−1)% x (where x is the total number of nodes), reduces the received data with its own data, saves the reduced data, and, if the node is not equal to the total number of nodes minus one (n ≠ x−1) sends the reduced data to node (n+1)% x. This is equivalent to a parallel prefix reduction among the ranks 0, 1, 2, . . . x−1, starting at node 0 and ending at node x−1. In the other direction, a node (where n ≠ x−1) receives data from node (n+1)% x, saves the received data, reduces the received data with its own data, and (if the node does not equal zero), and sends the reduced data to node (n−1)% x. This is equivalent to a parallel exclusive prefix reduction among the nodes x−1, x−2, . . . 1, 0 starting at node x−1 and ending at node 0. The reason for the exclusive prefix reduction in one of the directions, as compared to a prefix reduction in the other direction, is so that the node's own data is only counted once in the collective communication operation. Therefore, in one direction, the node stores results of the received data reduced with its own data while in the other direction, only the received data is stored. For example, on a process p, a parallel scan in one direction, left to right, gives the result d₀+d₁+ . . . dₚ and in the other direction, right to left, a parallel exclusive scan gives the result dₚ₋₁, +dₚ₋₂, . . . dₙ₋₁. Adding the two values gives the required result on all processes. Because the parallel prefix reduction operations occur concurrently on a bi-directional chain network, the time taken by the two concurrent parallel prefix reductions is (n−1)(α+(β+γ)s)+max(β,γ)(m−s)+γs and the process does not require a broadcast. In some examples, this can save about (n−1)(α+βs) units of time.

Multiple bi-directional chain networks or edge disjointed rings can be formed in many network topologies including n-dimensional torus, dragonfly (for example, with multiple network cards per node), etc. and network-contentions are not present in multiple bi-directional chain networks or edge disjointed rings. The time calculations assume that the rings do not share any network resources and can drive network traffic without interference. When more than one bi-directional chain network or edge disjointed ring can be formed in a network, the input data can be divided equally amount each pair of bi-directional chain networks or edge disjointed rings and the collective communication operations can be executed independently on the divided data. For example, an area or collection of data can be divided into chunks and each chunk can be sent one after the other.

Elements of FIG. 1 may be coupled to one another through one or more interfaces employing any suitable connections (wired or wireless), which provide viable pathways for network communications. Additionally, any one or more of these elements of FIG. 1 may be combined or removed from the architecture based on particular configuration needs. System 100 may include a configuration capable of transmission control protocol/Internet protocol (TCP/IP) communications for the transmission or reception of packets in a network. System 100 may also operate in conjunction with a user datagram protocol/IP (UDP/IP) or any other suitable protocol where appropriate and based on particular needs.

Turning to the infrastructure of FIG. 1, system 100 in accordance with an example embodiment is shown. Generally, system 100 can be implemented in any type or topology of networks that enables or allows for the teaching and examples disclosed herein. System 100 represent a series of points or nodes of interconnected communication paths for receiving and transmitting packets of information that propagate through system 100. System 100 offers a communicative interface between nodes, and may be configured as a collective network, parallel computing network, multi-level direct network, dragonfly topology network, multi-level dragonfly topology network, a local area network (LAN), virtual local area network (VLAN), wide area network (WAN), wireless local area network (WLAN), metropolitan area network (MAN), Intranet, Extranet, virtual private network (VPN), and any other appropriate architecture or system that facilitates collective communications in a network environment, or any suitable combination thereof, including wired and/or wireless communication.

In system 100, network traffic, which is inclusive of packets, frames, signals (analog, digital or any combination of the two), data, etc., can be sent and received according to any suitable communication messaging protocols. Suitable communication messaging protocols can include MPI, a multi-layered scheme such as Open Systems Interconnected (OSI) model, or any derivations or variants thereof (e.g., Transmission Control Protocol/Internet Protocol (TCP/IP), user datagram protocol/IP (UDP/IP)). Additionally, radio signal communications (e.g., over a cellular network) may also be provided in system 100. Suitable interfaces and infrastructure may be provided to enable communication with the cellular network.

The term “packet” as used herein, refers to a unit of data that can be routed between a source node and a destination node on a packet switched network. A packet includes a source network address and a destination network address. These network addresses can be Internet Protocol (IP) addresses in a TCP/IP messaging protocol. The term “data” as used herein, refers to any type of binary, numeric, voice, video, textual, or script data, or any type of source or object code, or any other suitable information in any appropriate format that may be communicated from one point to another in electronic devices and/or networks. Additionally, messages, requests, responses, and queries are forms of network traffic, and therefore, may comprise packets, frames, signals, data, etc.

Nodes (e.g., nodes 102a-102d) can include memory elements (e.g., memory 106a-106d respectively) for storing information to be used in the operations outlined herein. Each node may keep information in any suitable memory element (e.g., random access memory (RAM), read-only memory (ROM), erasable programmable ROM (EPROM), electrically erasable programmable ROM (EEPROM), application specific integrated circuit (ASIC), non-volatile memory (NVRAM), magnetic storage, magneto-optical storage, flash storage (SSD), etc.), software, hardware, firmware, or in any other suitable component, device, element, or object where appropriate and based on particular needs. Any of the memory items discussed herein should be construed as being encompassed within the broad term ‘memory element.’ Moreover, the information being used, tracked, sent, or received in system 100 could be provided in any database, register, queue, table, cache, control list, or other storage structure, all of which can be referenced at any suitable timeframe. Any such storage options may also be included within the broad term ‘memory element’ as used herein.

Additionally, each node ((e.g., nodes 102a-102d) may include a processor that can execute software or an algorithm to perform activities as discussed herein. A processor can execute any type of instructions associated with the data to achieve the operations detailed herein. In one example, each processor can transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an EPROM, an EEPROM) or an ASIC that includes digital logic, software, code, electronic instructions, or any suitable combination thereof. Any of the potential processing elements, modules, and machines described herein should be construed as being encompassed within the broad term ‘processor.’

In an example implementation, the nodes (e.g., nodes 102a-102d) are network elements, meant to encompass network appliances, servers (both virtual and physical), processors, modules, or any other suitable virtual or physical device, component, element, or object operable to process and exchange information in a collective communication network environment. Network elements may include any suitable hardware, software, components, modules, or objects that facilitate the operations thereof, as well as suitable interfaces for receiving, transmitting, and/or otherwise communicating data or information in a network environment. This may be inclusive of appropriate algorithms and communication protocols that allow for the effective exchange of data or information.

In certain example implementations, the functions outlined herein may be implemented by logic encoded in one or more tangible media (e.g., embedded logic provided in an ASIC, digital signal processor (DSP) instructions, software (potentially inclusive of object code and source code) to be executed by a processor, or other similar machine, etc.), which may be inclusive of non-transitory computer-readable media. In some of these instances, memory elements can store data used for the operations described herein. This includes the memory elements being able to store software, logic, code, or processor instructions that are executed to carry out the activities described herein.

In an example implementation, network elements of system 100, such as the nodes (e.g., nodes 102a-102d)) may include software modules (e.g., collective operations engine 104a-104d respectively) to achieve, or to foster, operations as outlined herein. These modules may be suitably combined in any appropriate manner, which may be based on particular configuration and/or provisioning needs. In some embodiments, such operations may be carried out by hardware, implemented externally to these elements, or included in some other network device to achieve the intended functionality. Furthermore, the modules can be implemented as software, hardware, firmware, or any suitable combination thereof. These elements may also include software (or reciprocating software) that can coordinate with other network elements in order to achieve the operations, as outlined herein.

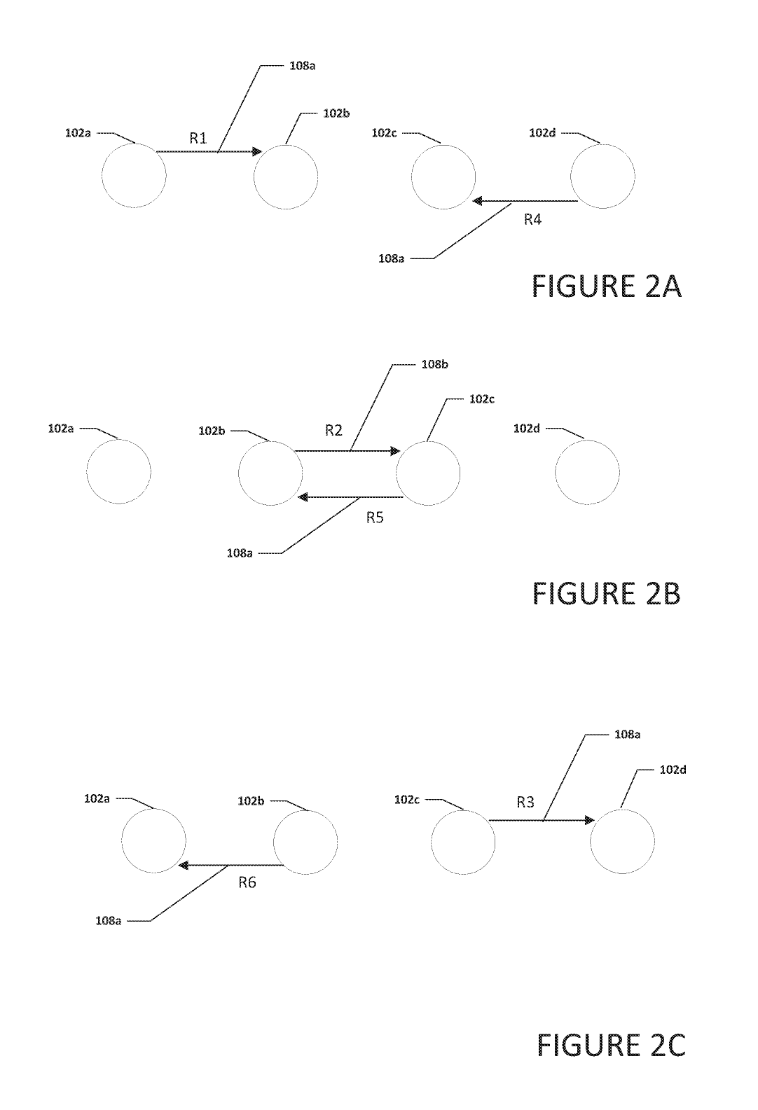

Turning to FIGS. 2A-2C, FIGS. 2A-2C are block diagrams illustrating example details of system 100. In an example, as illustrated in FIG. 2A, in a first direction, node 102a can communicate data R1 for a collective communication operation to node 102b on communication path 108a and in an opposite second direction, node 102d can communication data R4 for the collective communication operation to node 102c on communication path 108d. As illustrated in FIG. 2B, in the first direction, node 102b can receive data R1 from node 102a, perform the reduction operation that is part of the collective communication operation, store the results in memory (e.g., memory 106b), and send the data R2 (the results of the reduction operation that is part of the collective communication operation using the data from node 102a and 102b) to node 102c on communication path 108b. Also, in the opposite second direction, node 102c can receive data R4 from node 102d, perform the reduction operation that is part of the collective communication operation, store the results in memory (e.g., memory 106c), and send the data R5 (the results of the reduction operation that is part of the collective communication operation using the data from node 102d and 102c) to node 102b on communication path 108e.

As illustrated in FIG. 2C, in the first direction, node 102c can receive data R2 (the results of the reduction operation that is part of the collective communication operation using the data from node 102a and 102b) from node 102b, perform the reduction operation that is part of the collective communication operation using the saved results of the reduction operation that is part of the collective communication operation using the data from node 102d and 102c, perform the reduction operation that is part of the collective communication operation using nodes 102c's data and the results of the reduction operation that is part of the collective communication operation using the data from node 102a and 102b, and send the data R3 (the results of the reduction operation that is part of the collective communication operation using the data from nodes 102a, 102b, and 102c) to node 102d on communication path 108c. Node 102d can receive the data R3 from node 102c and perform the reduction operation that is part of the collective communication operation.

Also, in the opposite second direction, node 102b can receive data R5 (the results of the reduction operation that is part of the collective communication operation using the data from node 102c and 102d) from node 102c, perform the reduction operation that is part of the collective communication operation using the saved results of the reduction operation that is part of the collective communication operation using the data from node 102a and 102b, perform the reduction operation that is part of the collective communication operation using nodes 102b's data and the results of the reduction operation that is part of the collective communication operation using the data from node 102c and 102d, and send the data R6 (the results of the reduction operation that is part of the collective communication operation using the data from nodes 102b, 102c, and 102d) to node 102a on communication path 108f. Node 102a can receive the data R6 from node 102b and perform the reduction operation that is part of the collective communication operation. As a result, each node 102a-102b will have the final results of the collective communication operation without requiring a broadcast of the final results.

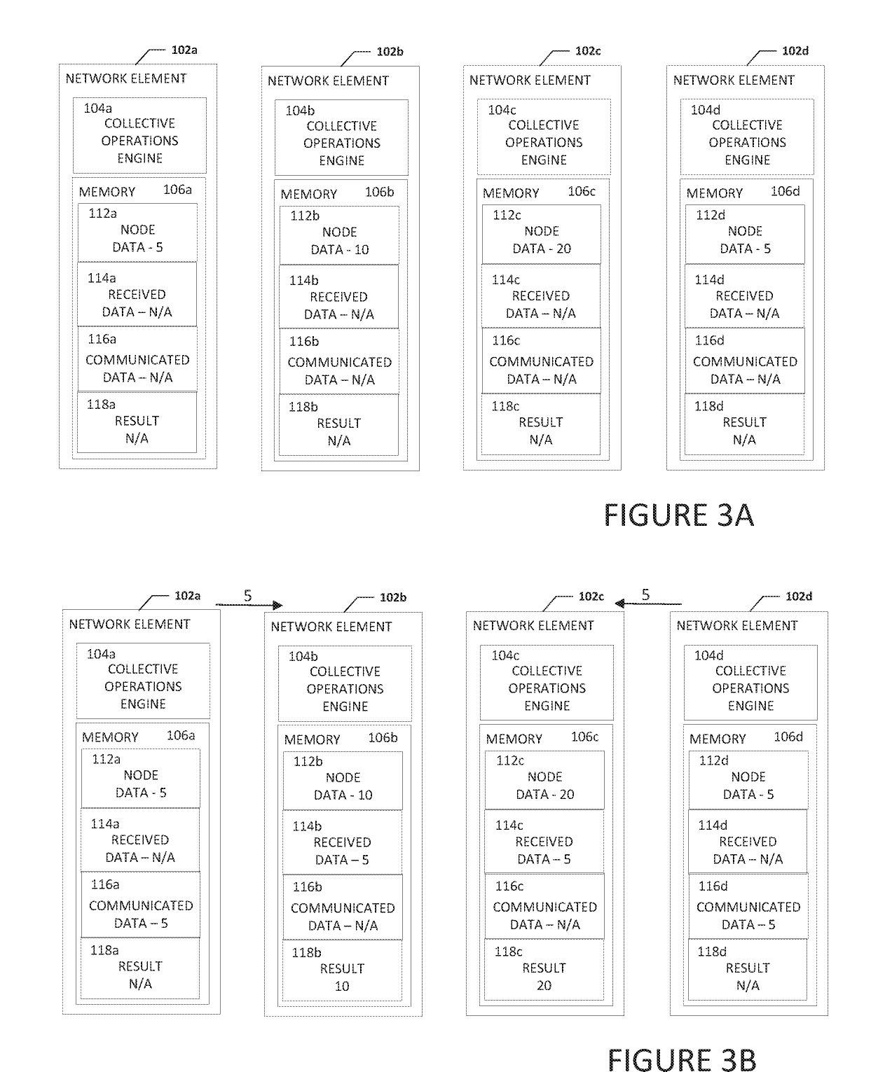

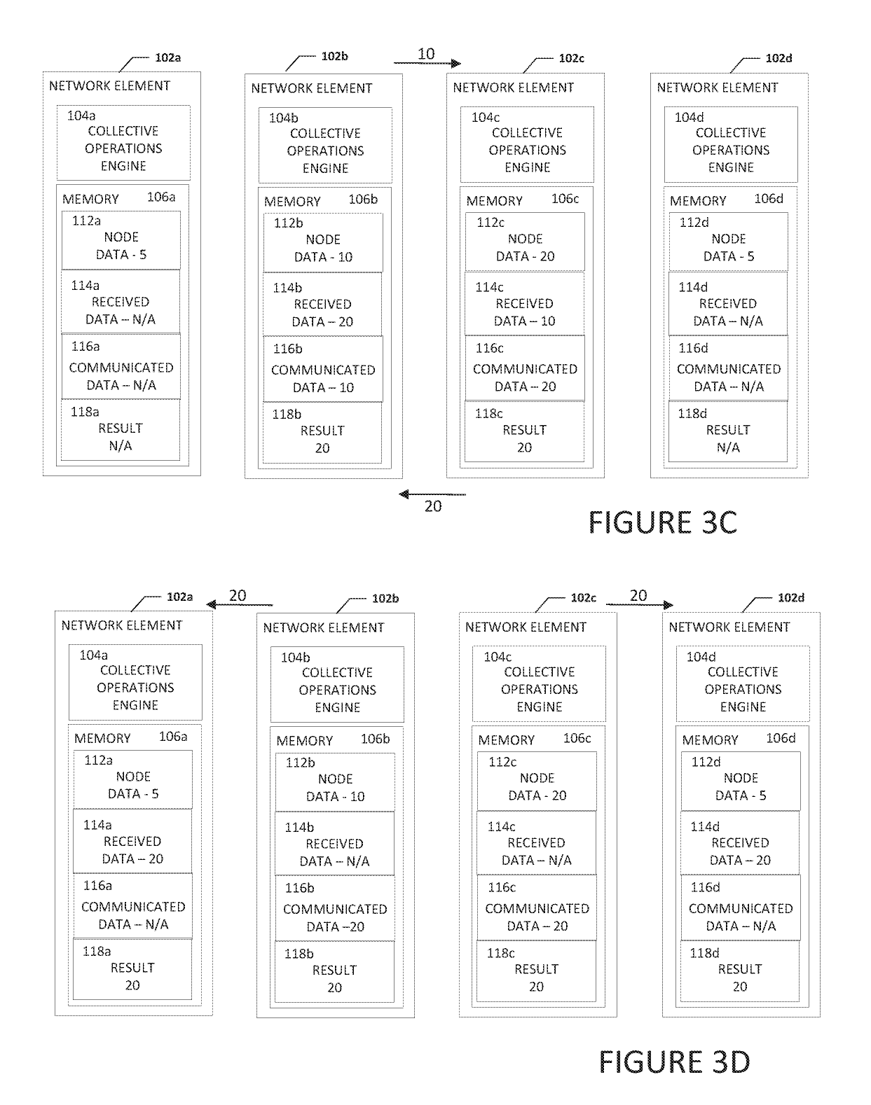

Turning to FIGS. 3A-3D, FIGS. 3A-3D are block diagrams of example details of a portion of a system to enable a collective communication operation. Node 102a can include collective operations engine 104a and memory 106a. Memory 106a can include node data 112a, received data 114a, communicated data 116a, and result 118a. Node 102b can include collective operations engine 104b and memory 106b. Memory 106b can include node data 112b, received data 114b, communicated data 116b, and result 118b. Node 102c can include collective operations engine 104c and memory 106c. Memory 106c can include node data 112c, received data 114c, communicated data 116c, and result 118c. Node 102d can include collective operations engine 104d and memory 106d. Memory 106d can include node data 112d, received data 114d, communicated data 116d, and result 118d.

Each node 102a-102d may be a network element. Each of node data 112a-112d can include data on the respective node that will be used in a reduction operation that is part of a collective communication operation. Each of received data 114a-114d can include data that has been received from another node. Each of communicated data 116a-116d can include data that has been communicated to another node. Each of results 118a-118d can include intermediate results of a reduction operation that is part of the collective communication operation or the final results of the collective communication operation. The data in results 118a-118d may be intermediate results when the reduction operation was performed using data from only one direction or final results when the reduction operation was performed using data from both directions.

FIG. 3A represents nodes 102a-102d before the collective communication operation and before any data has been sent. Node data 112a in node 102a is 5 (e.g., node data 112a represents a value of 5), node data 112b in node 102b is 10, node data 112c in node 102c is 20, and node data 112d in node 102d is 5. If the collective communication operation is a MAX operation where a maximum value is determined, then the result at the end of the collective communication operation would be 20.

At the start of the collective communication operation, as illustrated in FIG. 3B, node 102a sends its data of 5 (from node data 112a) to node 102b. Node 102b receives the data as illustrated in received data 114b, performs the reduction operation that is part of the collective communication operation, a MAX of 5 from node 102a and the data in node data 112b, which is 10, and stores the result of 10 (the maximum value) in result 118b. The result is an intermediate result as data from the other direction has yet to be received. Also, node 102d sends its data of 5 (from node data 112d) to node 102c. Node 102c receives the data as illustrated in received data 114c, performs the MAX operation that is part of the collective communication operation, a MAX of 5 from node 102d and the data in node data 112c, which is 20, and stores the result of 20 (the maximum value) in result 118c. The result is an intermediate result as data from the other direction has yet to be received.

As illustrated in FIG. 3C, node 102b sends the results of the reduction operation that is part of the collective communication operation of the data in node 102a and 102b (i.e., 10) to node 102c as illustrated in communicated data 116b. Node 102c receives the data as illustrated in received data 114c, performs the MAX operation that is part of the collective communication operation, a MAX operation of 10 from node 102b and the data in results 118c in node data 112c, which is 20 as illustrated in FIG. 3B, and stores the result of 20 in result 118c. Also, node 102c sends the results (i.e., 20) of the MAX operation that is part of the collective communication operation of the data in node 102c and 102d to node 102b as illustrated in communicated data 116c. Node 102b receives the data as illustrated in received data 114b, performs the MAX operation that is part of the collective communication operation, a MAX operation of 20 from node 102c and the data in results 118b in node data 112b, which is 10 as illustrated in FIG. 3B, and stores the result of 20 in result 118b.

As illustrated in FIG. 3D, node 102b performs the reduction operation and the result of the reduction operation (i.e., 20) is communicated to node 102a as illustrated in communicated data 116b. Node 102a receives the data of 20 as illustrated in received data 114a, performs the MAX operation that is part of the collective communication operation, a MAX operation of 20 from node 102b and the data in node data 112a, which is 5, and stores the result of 20 in result 118a. Because node 102b has already used the data in node data 112b in the reduction operation that is part of the collective communication operation, the results of the reduction operation are not stored to help prevent the data in node data 112b from being used twice in the reduction operation that is part of the collective communication operation. Also, node 102c performs the reduction operation and the result of the reduction operation (i.e., 20) is communicated to node 102d as illustrated in communicated data 116c. Because node 102c has already used the data in node data 112c in the reduction operation that is part of the collective communication operation, the results of the reduction operation are not stored to help prevent the data in node data 112c from being used twice in the reduction operation that is part of the collective communication operation. Node 102d receives the data of 20 as illustrated in received data 114d, performs the MAX operation that is part of the collective communication operation, a MAX operation of 20 from node 102c and the data in node data 112d, which is 5, and stores the result of 20 in result 118d. As a result, each node 102a-102d will have the final results of the collective communication operation without requiring a broadcast of the final results.

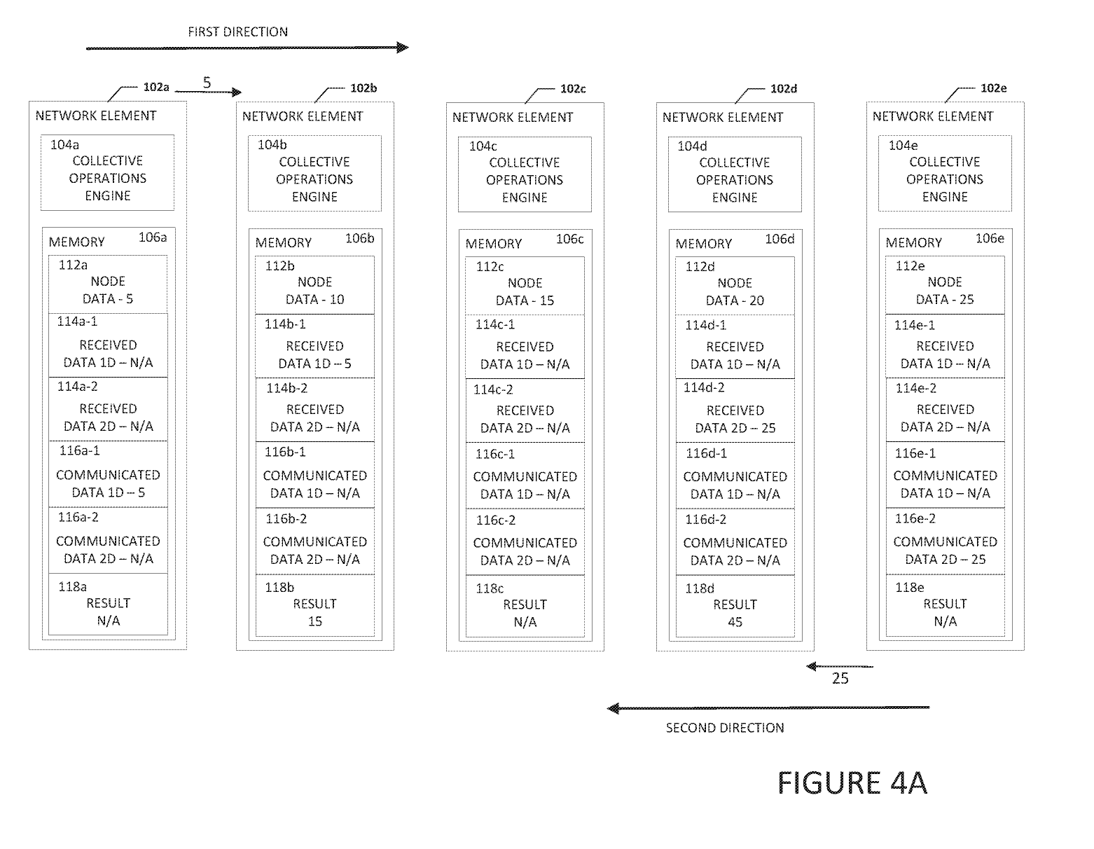

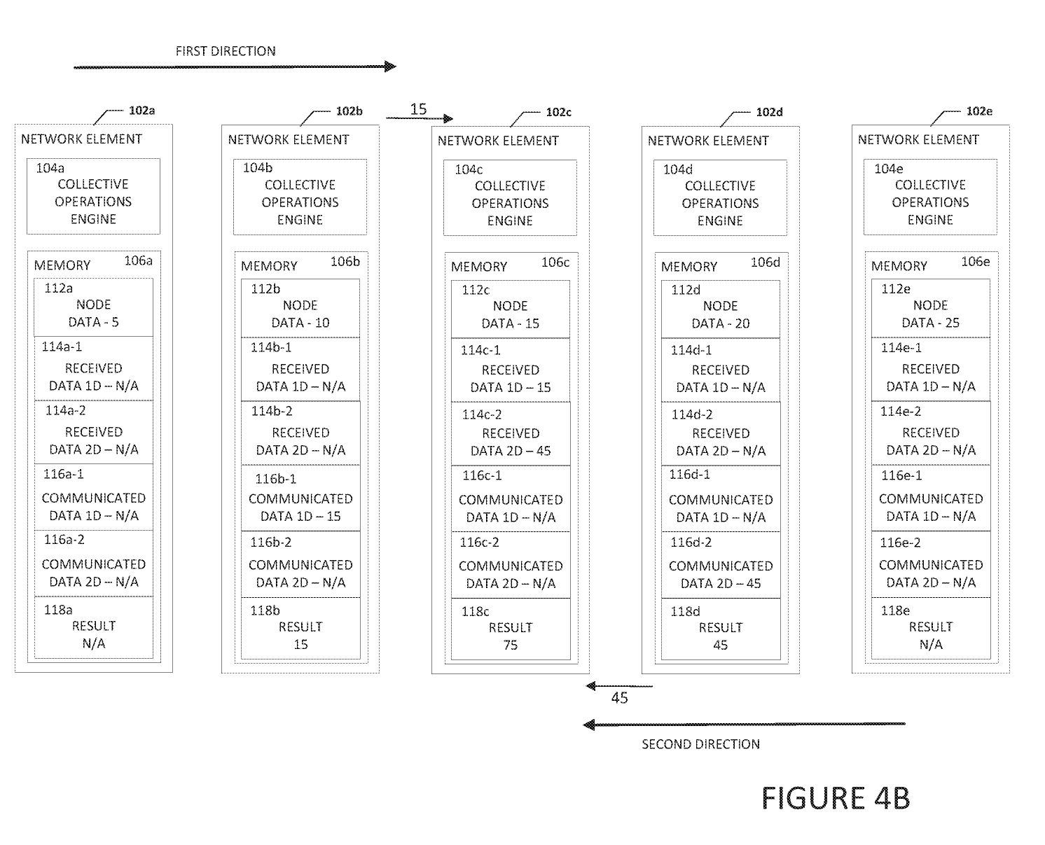

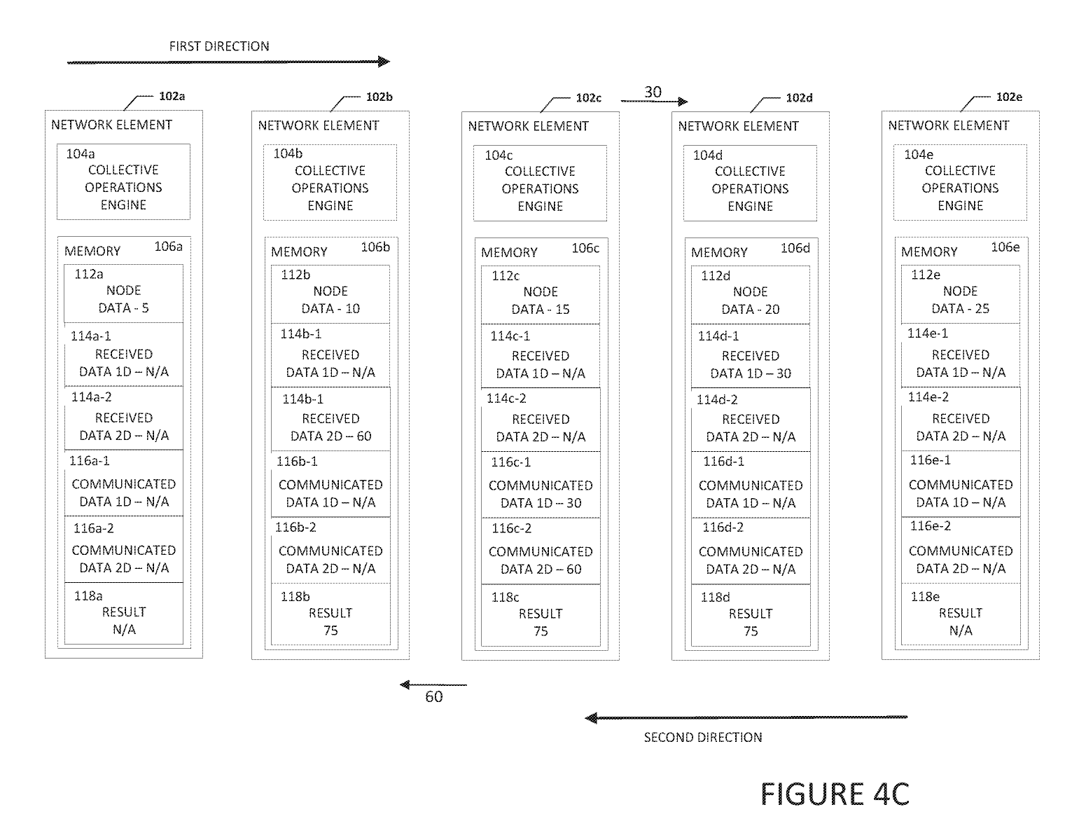

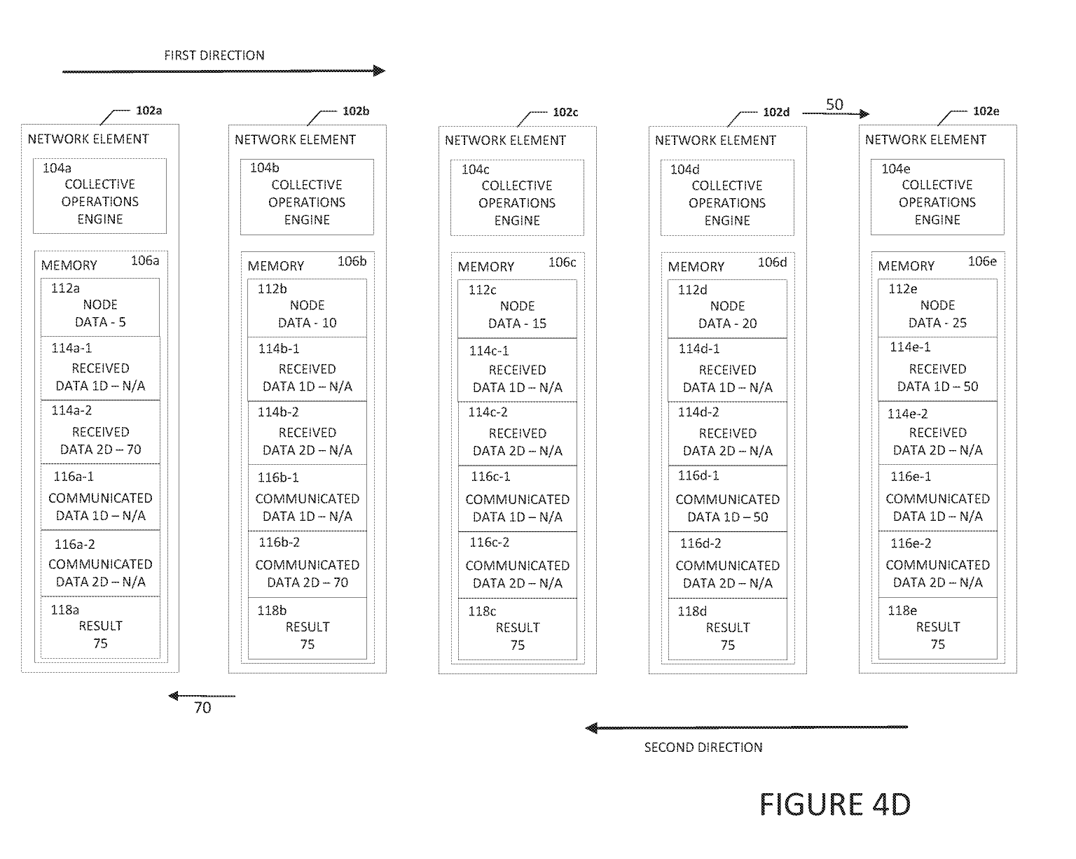

Turning to FIGS. 4A-4D, FIGS. 4A-4D are block diagrams of example details of a portion of a system to enable a collective communication operation. As illustrated in FIGS. 4A-4D, a bi-directional chain network can include nodes 102a-102e. Node 102a can include collective operations engine 104a and memory 106a. Memory 106a can include node data 112a, received data from first direction 114a-1, received data from second direction 114a-2, communicated data in first direction 116a-1, communicated data in second direction 116a-2, and result 118a. Node 102b can include collective operations engine 104b and memory 106b. Memory 106b can include node data 112b, received data from first direction 114b-1, received data from second direction 114b-2, communicated data in first direction 116b-1, communicated data in second direction 116b-2, and result 118b. Node 102c can include collective operations engine 104c and memory 106c. Memory 106c can include node data 112c, received data from first direction 114c-1, received data from second direction 114c-2, communicated data in first direction 116c-1, communicated data in second direction 116c-2, and result 118c. Node 102d can include collective operations engine 104d and memory 106d. Memory 106d can include node data 112d, received data from first direction 114d-1, received data from second direction 114d-2, communicated data in first direction 116d-1, communicated data in second direction 116d-2, and result 118d. Node 102e can include collective operations engine 104e and memory 106e. Memory 106e can include node data 112e, received data from first direction 114e-1, received data from second direction 114e-2, communicated data in first direction 116e-1, communicated data in second direction 116e-2, and result 118e.

Each of node data 112a-112e can include data on the respective node that will be used in a reduction operation that is part of the collective communication operation. Node data 112a in node 102a is 5, node data 112b in node 102b is 10, node data 112c in node 102c is 15, node data 112d in node 102d is 20, and node data 112e in node 102e is 25. If the collective communication operation is a SUM operation where each of the values are added, then the result at the end of the collective communication operation would be 75 (5+10+15++20+25=75).

Each of received data from first direction 114a-1-114e-1 can include data that has been received from another node from the first direction. Each of received data from second direction 114a-2-114e-2 can include data that has been received from another node from the second direction. Each of communicated data in first direction 116a-1-116e-1 can include data that has been communicated to another node in the first direction. Each of communicated data in second direction 116a-2-116e-2 can include data that has been communicated to another node in the second direction. Each of results 118a-118e can include intermediate results of a reduction operation that is part of the collective communication operation and the final results of the collective communication operation. The data in results 118a-118d may be intermediate results such as when data from only one direction has been received and used in the reduction operation that is part of the collective communication operation or end results when data from both directions has been received and used in the reduction operation that is part of the collective communication operation.

At the start of the collective communication operation, as illustrated in FIG. 4A, in the first direction, node 102a sends its data of 5 in node data 112a to node 102b. Node 102b receives the data as illustrated in received data from the first direction 114b-1, performs the reduction operation that is part of the collective communication operation, a sum of 5 from node 102a and the data in node data 112b, which is 10, and stores the result of 15 in result 118b. The result is an intermediate result as data from the other direction has yet to be received. Also, in the opposite second direction, node 102e sends its data of 25 in node data 112e to node 102d. Node 102d receives the data as illustrated in received data from second direction 114d-2, performs the reduction operation that is part of the collective communication operation, a sum of 25 from node 102e and the data in node data 112d, which is 20, and stores the result of 45 in result 118d. The result is an intermediate result as data from the other direction has yet to be received.

As illustrated in FIG. 4B, node 102b sends the results (i.e., 15) of the reduction operation that is part of the collective communication operation of the data in node 102a and 102b (5 from node 102a plus 10 from node 102b) to node 102c as illustrated in communicated data in first direction 116b-1. Node 102d receives the data as illustrated in received data from first direction 114d-1. Also, node 102d sends the results (i.e., 45) of the reduction operation that is part of the collective communication operation of the data in node 102d and 102e (20 from node 102d plus 25 from node 102e) to node 102c as illustrated in communicated data in second direction 116c-2. Node 102c receives the data from node 102d as illustrated in received data from second direction 114c-2. Collective operations engine 104c in node 102c can use the data in received data from first direction 114a-1, which is 15, the data in received data from second direction 114a-2, which is 45, and the data in node data 112c, which is 15, and perform the reduction operation that is part of the collective communication operation and obtain a result of 75. The result is stored in result 118c. Because data has been received from both direction, the result is a final or end result.

As illustrated in FIG. 4C, node 102c sends the results (i.e., 30) of the reduction operation that is part of the collective communication operation of the data in nodes 102a and 102b (5 from node 102a plus 10 from node 102b) and the data in node 102c, which is 15, to node 102d as illustrated in communicated data in the first direction 116c-1. Node 102c receives the data as illustrated in received data from the first direction 114c-1, performs the reduction operation that is part of the collective communication operation, a sum of 30 from node 102c and the data in results 118d in node data 112d, which is 45 as illustrated in FIG. 4B, and stores the result of 75 in result 118d. Because data has been received from both direction, the result is a final or end result. Also, node 102c sends the results (i.e., 45) of the reduction operation that is part of the collective communication operation of the data in node 102d and 102e (20 from node 102d plus 25 from node 102e) and the data in node 102c, which is 15, to node 102b as illustrated in communicated data in the second direction 116c-2. Node 102b receives the data as illustrated in received data from the second direction 114b-2, performs the reduction operation that is part of the collective communication operation, a sum of 60 from node 102c and the data in results 118b in node data 112b, which is 15 as illustrated in FIG. 4B, and stores the result of 75 in result 118b. Because data has been received from both direction, the result is a final or end result.

As illustrated in FIG. 4D, node 102b performs the reduction operation, the sum of the received data 60 from node 102c and the data in node data 110b, which is 10, and communicates the results (i.e., 70) to node 102a as illustrated in communicated data in the second direction 116b-1. Because node 102b has already used the data in node data 112b in the reduction operation that is part of the collective communication operation, the results of the reduction operation are not stored to help prevent the data in node data 112b from being used twice in the reduction operation that is part of the collective communication operation. Node 102a receives the data of 70 as illustrated in received data from the second direction 114a-2, performs the reduction operation that is part of the collective communication operation, a sum of 70 from node 102b and the data in node data 112a, which is 5, and stores the result of 75 in result 118a. Also, node 102d performs the reduction operation, the sum of the received data 30 from node 102c and the data in node data 110d, which is 20, and communicates the results (i.e., 50) to node 102e as illustrated in communicated data in the first direction 116c-1. Because node 102d has already used the data in node data 112d in the reduction operation that is part of the collective communication operation, the results of the reduction operation are not stored to help prevent the data in node data 112d from being used twice in the reduction operation that is part of the collective communication operation. Node 102e receives the data of 50 as illustrated in received data from the first direction 114d-1, performs the reduction operation that is part of the collective communication operation, a sum of 70 from node 102d and the data in node data 112e, which is 25, and stores the result of 75 in result 118e. As a result, each node 102a-102e will have the final results of the collective communication operation without requiring a broadcast of the final results.

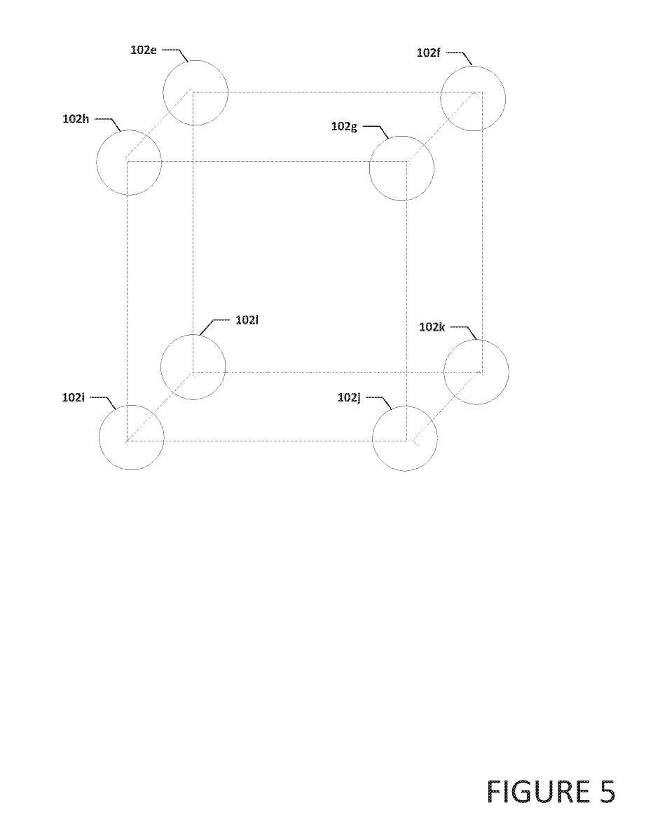

Turning to FIG. 5, FIG. 5 is a block diagram of a portion of system 200. System 200 can include nodes 102e-102l arranged in a hypercube network topology. While a hypercube network topology is illustrated in FIG. 5, other network topologies (e.g., ring, mesh, hybrid, etc.) may be used.

In an example, nodes 102e-102l can be organized as a bi-directional chain network where the bi-directional path is from node 102e, to node 102f, to node 102g, to node 102h, to node 102i, to node 102j, to node 102k, and to node 102l. In another example, nodes 102e-102l can be organized as a bi-directional chain network where the bi-directional path is from node 102k, to node 102f, to node 102g, to node 102h, to node 102e, to node 102l, to node 102i, and to node 102j. It should be appreciated that other bi-directional chain networks can be organized. In some examples, more than one bi-directional chain network or edge disjointed rings can be formed and the input data for the collective communication operation can be divided equally amount each pair of rings and the allreduce process can be executed independently on the divided data.

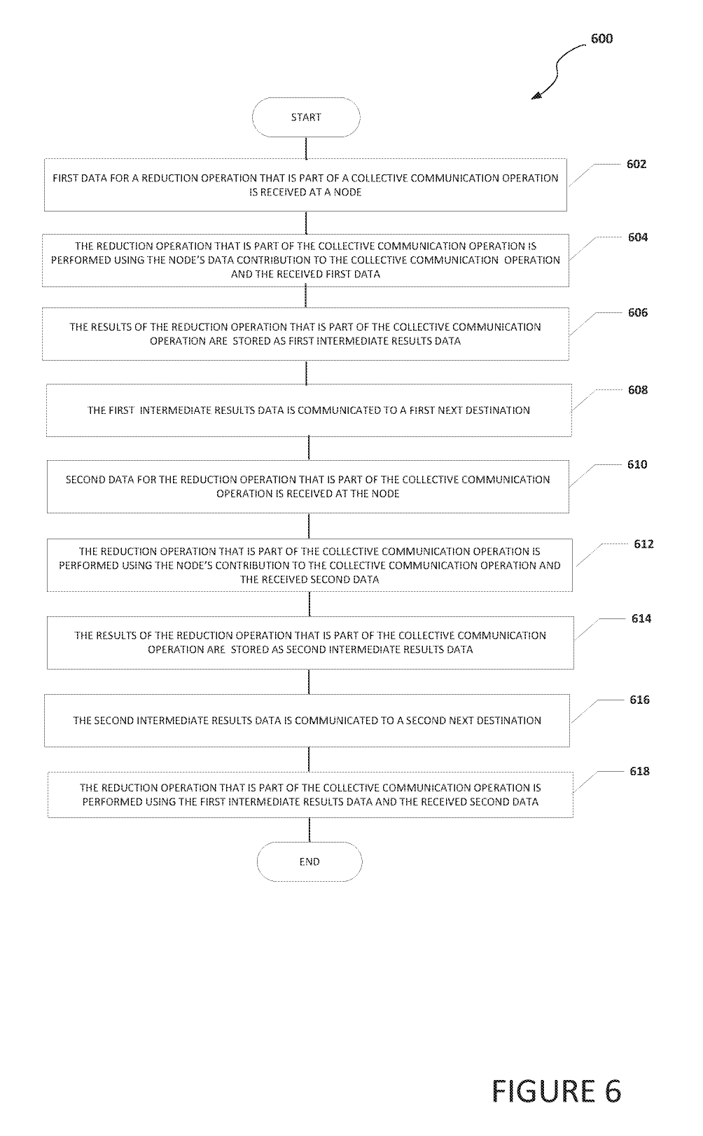

Turning to FIG. 6, FIG. 6 is an example flowchart illustrating possible operations of a flow 600 that may be associated with a collective communication operation, in accordance with an embodiment. In an embodiment, one or more operations of flow 600 may be performed by collective operations engine 104. At 602, first data for a reduction operation that is part of a collective communication operation is received at a node. At 604, the reduction operation that is part of the collective communication operation is performed using the node's data contribution to the collective communication operation and the received first data. At 606, the results of the reduction operation that is part of the collective communication operation are stored as first intermediate results data. The first intermediate results include the received first data and the node's data contribution to the collective communication operation. At 608, the first intermediate results data is communicated to a first next destination. At 610, second data for the reduction operation that is part of the collective communication operation is received at the node. At 612, the reduction operation that is part of the collective communication operation is performed using the node's contribution to the collective communication operation and the received second data. At 614, the results of the reduction operation that is part of the collective communication operation are stored as second intermediate results data. The second intermediate results data includes the received second data and the node's contribution to the collective communication operation. In an example, the second intermediate results data can be stored in temporary memory. At 616, the second intermediate results data is communicated to a second next destination. In an example, after the second intermediate results data is communicated to the next destination, the data can be removed, deleted, flushed, allowed to be overwritten, etc. from the temporary memory. At 618, the reduction operation that is part of the collective communication operation is performed using the first intermediate results data and the received second data. Because data has been received from both direction, the result is a final or end result of the collective communication operation. The reduction operation is performed using the first intermediate results data and the received second data, instead of the second intermediate results data to help prevent a nodes own data from counting twice in the reduction operation that is part of the collective communication operation.

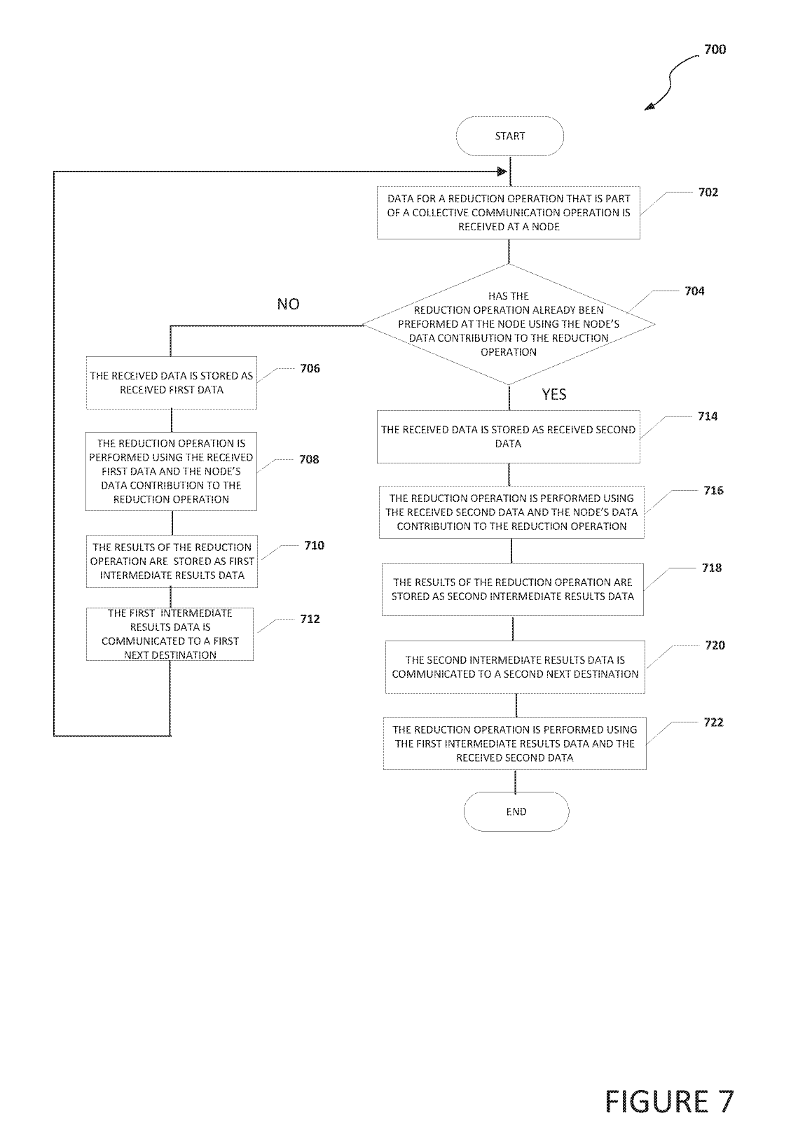

Turning to FIG. 7, FIG. 7 is an example flowchart illustrating possible operations of a flow 700 that may be associated with a collective communication operation, in accordance with an embodiment. In an embodiment, one or more operations of flow 700 may be performed by collective operations engine 104. At 702, data for a reduction operation that is part of a collective communication operation is received at a node. At 704, the system determines if the reduction operation has already been performed at the node using the node's data contribution to the reduction operation. If the reduction operation has not already been performed at the node using the node's data contribution, then the received data is stored as received first data, as in 706. At 708, the reduction operation is performed using the received first data and the node's data contribution to the reduction operation. At 710, the results of the reduction operation are stored as first intermediate results data. At 712, the first intermediate results data is communicated to a first next destination and the system returns to 702.

If the reduction operation has already been performed at the node using the node's data contribution to the reduction operation, then the received data is stored as received second data, as in 714. At 716, the reduction operation is performed using the received second data and the node's data contribution to the reduction operation. At 718, the results of the reduction operation are stored as second intermediate results data. At 720, the second intermediate results data is communicated to a second next destination. In an example, the second intermediate results data can be stored in temporary memory and after the second intermediate results data is communicated to the next destination, the data can be removed, deleted, flushed, allowed to be overwritten, etc. from the temporary memory. At 722, the reduction operation is performed using the first intermediate results data and the received second data. The reduction operation is performed using the first intermediate results data and the received second data, instead of the second intermediate results data, to help prevent a nodes own data from counting twice in the reduction operation that is part of the collective communication operation. In an example, an area or collection of data can be divided into chunks and each chunk can be sent one after the other and the process can be iteratively repeated until all the chunks have moved across the network.

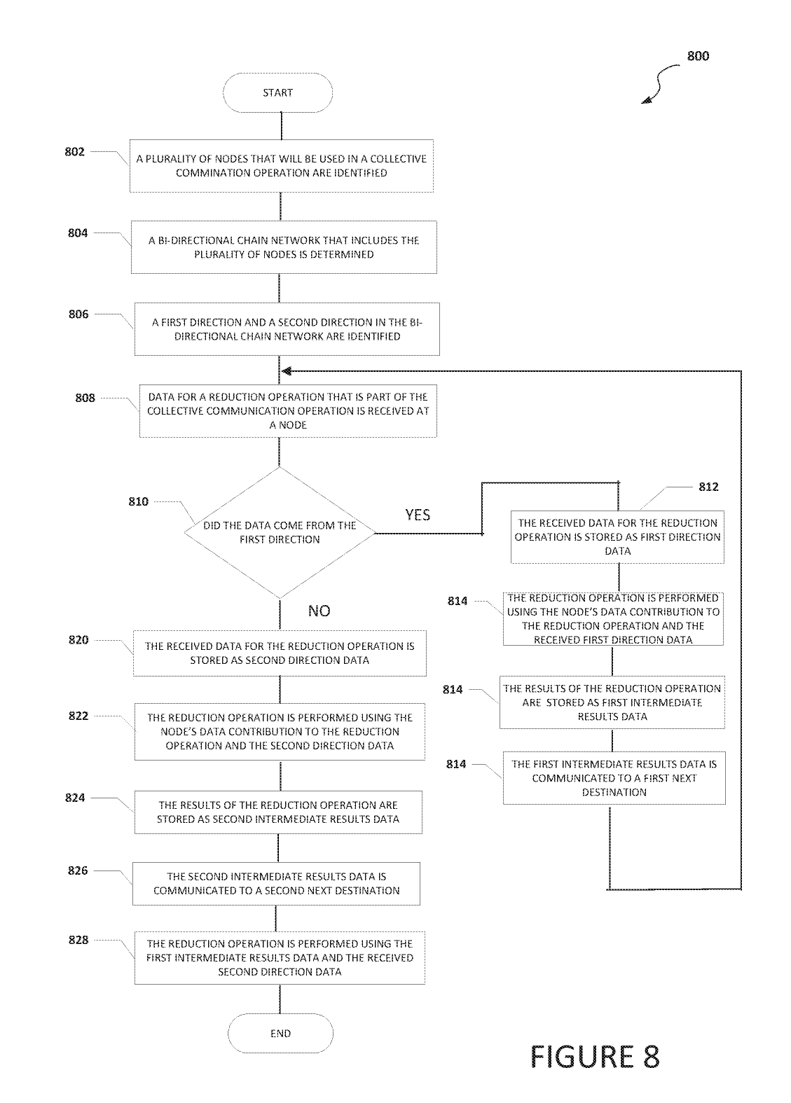

Turning to FIG. 8, FIG. 8 is an example flowchart illustrating possible operations of a flow 800 that may be associated with a collective communication operation, in accordance with an embodiment. In an embodiment, one or more operations of flow 800 may be performed by collective operations engine 104. At 802, a plurality of nodes that will be used in a collective communication operation are identified. At 804, a bi-directional chain network that includes the plurality of nodes is determined. At 806, a first direction and a second direction in the bi-directional chain network are identified. At 808, data for a reduction operation that is part of the collective communication operation is received at a node. At 810, the system determines if the data came from the first direction. If the data came from the first direction, then the received data for the reduction operation is stored as first direction data, as in 812. At 814, the reduction operation is performed using the node's data contribution to the reduction operation and the received first direction data. At 816, the results of the reduction operation are stored as first intermediate results data. At 818, the first intermediate results data is communicated to a first next destination and the system returns to 808 to receive data from the second direction.

If the data did not come from the first direction, then the received data for the reduction operation is stored as second direction data, as in 820. At 822, the reduction operation is performed using the node's data contribution to the reduction operation and the second direction data. At 824, the results of the reduction operation are stored as second intermediate results data. At 826, the second intermediate results data is communicated to a second next destination. In an example, the second intermediate results data can be stored in temporary memory and after the second intermediate results data is communicated to the next destination, the data can be removed, deleted, flushed, allowed to be overwritten, etc. from the temporary memory. At 828, the reduction operation is performed using the first intermediate results data and the received second direction data. The reduction operation is performed using the first intermediate results data and the received second data, instead of the second intermediate results data, to help prevent a nodes own data from counting twice in the reduction operation that is part of the collective communication operation. In an example, an area or collection of data can be divided into chunks and each chunk can be sent one after the other and the process can be iteratively repeated until all the chunks have moved across the network.

The term “first direction” is an arbitrary term used for illustration purposes only and can be defined as a direction from which a node first receives data. For example, with reference to FIGS. 3A-3D, if the first direction is from node 102a, 102b, 102c, and 102d then operation of flow 800 is only applicable to nodes 102a and 102b because nodes 102a and 102b will receive data in the first direction before receiving data in the second direction. Operation of flow 800 can be applicable to nodes 102c and 102d if the first direction is from node 102d, 102c, 102b, and 102a. With reference to FIGS. 4A-4D, node 102c is illustrated as receiving data from both directions at about the same time and operation of flow 800 is applicable to node 102c if the data from the first direction was received at 102c before the data from the second direction.

Note that with the examples provided herein, interaction may be described in terms of two, three, or more network elements. However, these embodiments are for purposes of clarity and example only, and are not intended to be limiting. In certain cases, it may be easier to describe one or more of the functionalities of a given set of flows by only referencing a limited number of network elements. It should be appreciated that system 100 and its teachings are readily scalable and can accommodate a large number of components, as well as more complicated/sophisticated arrangements and configurations. Accordingly, the examples provided should not limit the scope or inhibit the broad teachings of system 100 as potentially applied to a myriad of other architectures.

It is also important to note that the operations in the preceding flow diagrams (i.e., FIGS. 6-8) illustrate only some of the possible correlating scenarios and patterns that may be executed by, or within, system 100. Some of these operations may be deleted or removed where appropriate, or these operations may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by system 100 in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. Moreover, certain components may be combined, separated, eliminated, or added based on particular needs and implementations. Additionally, although system 100 has been illustrated with reference to particular elements and operations that facilitate the communication process, these elements and operations may be replaced by any suitable architecture, protocols, and/or processes that achieve the intended functionality of system 100.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

### OTHER NOTES AND EXAMPLES

Example C1 is at least one machine readable storage medium having one or more instructions that when executed by at least one processor, cause the at least one processor to receive data from a first node in a bi-directional chain of nodes, perform a reduction operation that is part of a collective communication operation using the data from the first node and data on the node to create a first intermediate result, store the first intermediate result in memory, communicate the first intermediate result to a second node, receive second data from the second node, perform the reduction operation that is part of the collective communication operation using the second data from the second node and the data on the node to create a second intermediate result, communicate the second intermediate result to the first node, perform the reduction operation that is part of the collective communication operation using the second data from the second node and the first intermediate result to create a collective communication operation result, and store the collective communication operation result in memory.

In Example C2, the subject matter of Example C1 can optionally include where the collective communication operation is an allreduce operation.

In Example C3, the subject matter of any one of Examples C1-C2 can optionally include where the reduction operation using the data from the first node is a prefix reduction operation.

In Example C4, the subject matter of any one of Examples C1-C3 can optionally include where the reduction operation using the data from the second node is the prefix reduction operation.

In Example C5, the subject matter of any one of Examples C1-C4 can optionally include where nodes in the chain of nodes are connected through an edge disjointed ring.

In Example C6, the subject matter of any one of Examples C1-C5 can optionally include where the first node and the second node are part of a multi-tiered topology network.

In Example C7, the subject matter of any one of Examples C1-C6 can optionally include where the first node and the second node are part of an interconnected network.

In Example S1, a system can include a plurality of nodes in a bi-directional chain of nodes, and at least one processor. The at least one processor can be configured to receive data from a first node in the bi-directional chain of nodes, perform a reduction operation that is part of a collective communication operation using the data from the first node and data on the node to create a first intermediate result, store the first intermediate result in memory, communicate the first intermediate result to a second node, receive second data from the second node, perform the reduction operation that is part of the collective communication operation using the second data from the second node and the data on the node to create a second intermediate result, communicate the second intermediate result to the first node, perform the reduction operation that is part of collective communication operation using the second data from the second node and the first intermediate result to create a collective communication operation result, and store the collective communication operation result in memory.

In Example, S2, the subject matter of Example S1 can optionally include where the collective communication operation is an allreduce operation.

In Example S3, the subject matter of any one of Examples S1-S2 can optionally include where the reduction operation using the data from the first node is a prefix reduction operation.

In Example S4, the subject matter of any one of Examples S1-S3 can optionally include where the reduction operation using the data from the second node is the prefix reduction operation.

In Example S5, the subject matter of any one of Examples S1-S4 can optionally include where nodes in the chain of nodes are connected through an edge disjointed ring.

In Example S6, the subject matter of any one of Examples S1-S5 can optionally include where the first node and the second node are part of a multi-tiered topology network.

In Example S7, the subject matter of any one of Examples S1-S6 can optionally include where the first node and the second node are part of an interconnected network.

Example A1 is an apparatus for providing a collective communication operation, the apparatus comprising at least one memory element, at least one processor coupled to the at least one memory element, a collective operations engine that cause the at least one processor to receive data from a first node in a bi-directional chain of nodes, perform a reduction operation that is part of a collective communication operation using the data from the first node and data on the node to create a first intermediate result, store the first intermediate result in memory, communicate the first intermediate result to a second node, receive second data from the second node, perform the reduction operation that is part of the collective communication operation using the second data from the second node and the data on the node to create a second intermediate result, communicate the second intermediate result to the first node, perform the reduction operation that is part of the collective communication operation using the second data from the second node and the first intermediate result to create a collective communication operation result, and store the collective communication operation result in memory.

In Example A2, the subject matter of Example A1 can optionally include where the collective communication operation is an allreduce operation.

In Example A3, the subject matter of any one of the Examples A1-A2 can optionally include where the reduction operation using the data from the first node is a prefix reduction operation.

In Example A4, the subject matter of any one of the Examples A1-A3 can optionally include where nodes in the chain of nodes are connected through an edge disjointed ring.

In Example A5, the subject matter of any one of the Examples A1-A4 can optionally include where the first node and the second node are part of a multi-tiered topology network.

Example M1 is a method including receiving data from a first node in a bi-directional chain of nodes, performing a reduction operation that is part of a collective communication operation using the data from the first node and data on the node to create a first intermediate result, storing the first intermediate result in memory, communicating the first intermediate result to a second node, receiving second data from the second node, performing the reduction operation that is part of the collective communication operation using the second data from the second node and the data on the node to create a second intermediate result, communicating the second intermediate result to the first node, performing the reduction operation that is part of the collective communication operation using the second data from the second node and the first intermediate result to create a collective communication operation result, and storing the collective communication operation result in memory.

In Example M2, the subject matter of Example M1 can optionally include where the collective communication operation is an allreduce operation.

In Example M3, the subject matter of any one of the Examples M1-M2 can optionally include where the reduction operation using the data from the first node is a prefix reduction operation.

In Example M4, the subject matter of any one of the Examples M1-M3 can optionally include where the reduction operation using the data from the second node is the prefix reduction operation.

In Example M5, the subject matter of any one of the Examples M1-M4 can optionally include where nodes in the chain of nodes are connected through an edge disjointed ring.

In Example M6, the subject matter of any one of the Examples M1-M5 can optionally include where the first node and the second node are part of a multi-tiered topology network

Example AA1 is an apparatus including means for receiving data from a first node in a bi-directional chain of nodes, performing a reduction operation that is part of a collective communication operation using the data from the first node and data on the node to create a first intermediate result, means for storing the first intermediate result in memory, means for communicating the first intermediate result to a second node, means for receiving second data from the second node, means for performing the reduction operation that is part of the collective communication operation using the second data from the second node and the data on the node to create a second intermediate result, means for communicating the second intermediate result to the first node, means for performing the reduction operation that is part of the collective communication operation using the second data from the second node and the first intermediate result to create a collective communication operation result, and means for storing the collective communication operation result in memory.

In Example AA2, the subject matter of Example AA1 can optionally include where the collective communication operation is an allreduce operation.

In Example AA3, the subject matter of any one of Examples AA1-AA2 can optionally include where the reduction operation using the data from the first node is a prefix reduction operation.

In Example AA4, the subject matter of any one of Examples AA1-AA3 can optionally include where the reduction operation using the data from the second node is the prefix reduction operation.

In Example AA5, the subject matter of any one of Examples AA1-AA4 can optionally include where nodes in the chain of nodes are connected through an edge disjointed ring.

In Example AA6, the subject matter of any one of Examples AA1-AA5 can optionally include where the first node and the second node are part of a multi-tiered topology network.

In Example AA7, the subject matter of any one of Examples AA1-AA6 can optionally include where the first node and the second node are part of an interconnected network.

Example X1 is a machine-readable storage medium including machine-readable instructions to implement a method or realize an apparatus as in any one of the Examples A1-A5, M1-M6, or AA1-AA7. Example Y1 is an apparatus comprising means for performing of any of the Example methods M1-M6. In Example Y2, the subject matter of Example Y1 can optionally include the means for performing the method comprising a processor and a memory. In Example Y3, the subject matter of Example Y2 can optionally include the memory comprising machine-readable instructions.

What is claimed is:

1. At least one machine readable non-transitory storage medium having instructions stored thereon, wherein the instructions, when executed by at least one processor cause the at least one processor to:
receive, at a node, data from a first node in a bi-directional chain of nodes;
perform a reduction operation that is part of a collective communication operation using the data from the first node and data on the node to create a first intermediate result;
store the first intermediate result in memory;
communicate the first intermediate result to a second node;
receive second data from the second node;
perform the reduction operation that is part of the collective communication operation using the second data from the second node and the data on the node to create a second intermediate result;
communicate the second intermediate result to the first node; and
perform the reduction operation that is part of the collective communication operation using the second data from the second node and the first intermediate result to create a collective communication operation result.

2. The at least one machine readable storage medium of claim 1, wherein the collective communication operation is an allreduce operation.

3. The at least one machine readable storage medium of claim 1, wherein the reduction operation using the data from the first node is a prefix reduction operation.

4. The at least one machine readable storage medium of claim 3, wherein the reduction operation using the data from the second node is the prefix reduction operation.

5. The at least one machine readable storage medium of claim 1, wherein nodes in the chain of nodes are connected through an edge disjointed ring.

6. The at least one machine readable storage medium of claim 1, wherein the first node and the second node are part of a multi-tiered topology network.

7. The at least one machine readable storage medium of claim 1, wherein the first node and the second node are part of an interconnected network.

8. A system comprising:
a plurality of nodes in a bi-directional chain of nodes; and
at least one processor configured to:
receive, at a node, data from a first node in the bi-directional chain of nodes;
perform a reduction operation that is part of a collective communication operation using the data from the first node and data on the node to create a first intermediate result;
store the first intermediate result in memory;
communicate the first intermediate result to a second node;
receive second data from the second node;
perform the reduction operation that is part of the collective communication operation using the second data from the second node and the data on the node to create a second intermediate result;
communicate the second intermediate result to the first node; and
perform the reduction operation that is part of collective communication operation using the second data from the second node and the first intermediate result to create a collective communication operation result.

9. The system of claim 8, wherein the collective communication operation is an allreduce operation.

10. The system of claim 8, wherein the reduction operation using the data from the first node is a prefix reduction operation.

11. The system of claim 10, wherein the reduction operation using the data from the second node is the prefix reduction operation.

12. The system of claim 8, wherein nodes in the chain of nodes are connected through an edge disjointed ring.

13. The system of claim 8, wherein the first node and the second node are part of a multi-tiered topology network.

14. The system of claim 8, wherein the first node and the second node are part of an interconnected network.

15. An apparatus for providing a collective communication operation, the apparatus comprising:
at least one memory element;
at least one processor coupled to the at least one memory element;
a collective operations engine, that causes the at least one processor to:
receive, at a node, data from a first node in a bi-directional chain of nodes;
perform a reduction operation that is part of a collective communication operation using the data from the first node and data on the node to create a first intermediate result;
store the first intermediate result in memory;
communicate the first intermediate result to a second node;
receive second data from the second node;
perform the reduction operation that is part of the collective communication operation using the second data from the second node and the data on the node to create a second intermediate result;
communicate the second intermediate result to the first node; and
perform the reduction operation that is part of the collective communication operation using the second data from the second node and the first intermediate result to create a collective communication operation result.

16. The apparatus of claim 15, wherein the collective communication operation is an allreduce operation.

17. The apparatus of claim 15, wherein the reduction operation using the data from the first node is a prefix reduction operation.

18. The apparatus of claim 15, wherein nodes in the chain of nodes are connected through an edge disjointed ring.

19. The apparatus of claim 15, wherein the first node and the second node are part of a multi-tiered topology network.

20. A method comprising:
receiving, at a node, data from a first node in a bi-directional chain of nodes;
performing a reduction operation that is part of a collective communication operation using the data from the first node and data on the node to create a first intermediate result;
storing the first intermediate result in memory;
communicating the first intermediate result to a second node;
receiving second data from the second node;
performing the reduction operation that is part of the collective communication operation using the second data from the second node and the data on the node to create a second intermediate result;
communicating the second intermediate result to the first node; and
performing the reduction operation that is part of the collective communication operation using the second data from the second node and the first intermediate result to create a collective communication operation result.

21. The method of claim 20, wherein the collective communication operation is an allreduce operation.

22. The method of claim 20, wherein the reduction operation using the data from the first node is a prefix reduction operation.

23. The method of claim 22, wherein the reduction operation using the data from the second node is the prefix reduction operation.

24. The method of claim 20, wherein nodes in the chain of nodes are connected through an edge disjointed ring.

25. The method of claim 20, wherein the first node and the second node are part of a multi-tiered topology network.
